(19) United States
(12) Patent Application Publication
(10) Pub. No.: US 2015/0085932 A1
(43) Pub. Date: Mar. 26, 2015

(54) METHOD AND APPARATUS OF MOTION VECTOR DERIVATION FOR 3D VIDEO CODING

(71) Applicant: MEDIATEK INC., Hsin-Chu, TW (TW)

(72) Inventors: Jian-Liang Lin, Yilan County (TW); Yi-Wen Chen, Taichung (TW); Yu-Pao Tsai, Kaohsiung (TW); Yu-Wen Huang, Taipei (TW); Shaw-Min Lei, Hsinchu County (TW)

(21) Appl. No.: 14/388,820

(22) PCT Filed: Apr. 9, 2013
(86) PCT No.: PCT/CN2013/073954

§ 371 Date: Sep. 29, 2014

Related U.S. Application Data
(60) Provisional application No. 61/637,749, filed on Apr. 24, 2012.
(60) Provisional application No. 61/639,593, filed on Apr. 27, 2012.
(60) Provisional application No. 61/672,792, filed on Jul. 18, 2012.

(51) Int. Cl. H04N 19/513; H04N 13/00

(52) U.S. Cl. CPC H04N 19/513; H04N 13/0048
USPC 375/240.16

(57) ABSTRACT

A method and apparatus for deriving MVP (motion vector predictor) for Skip or Merge mode in 3D video coding are disclosed. In one embodiment, the method comprises determining an MVP candidate set for a selected block and selecting one MVP from an MVP list for motion vector coding of the block. The MVP candidate set may comprise multiple spatial MVP candidates associated with neighboring blocks and one inter-view candidate, and the MVP list is selected from the MVP candidate set. The MVP list may consist of only one MVP candidate or multiple MVP candidates. If only one MVP candidate is used, there is no need to incorporate an MVP index associated with the MVP candidate in the video bitstream corresponding to the three-dimensional video coding. Also, the MVP candidate can be the first available MVP candidate from the MVP candidate set according to a pre-defined order.

### CROSS REFERENCE TO RELATED APPLICATIONS

The present invention claims priority to U.S. Provisional Patent Application Ser. No. 61/637,749, filed on Apr. 24, 2012, entitled “Direct/Skip mode with explicit signaling of the MVP index in 3D Video Coding”, U.S. Provisional Patent Application Ser. No. 61/639,593, filed on Apr. 27, 2012, entitled “The methods for MVP derivation in 3D Video Coding”, and U.S. Provisional Patent Application Ser. No. 61/672,792, filed on Jul. 18, 2012, entitled “Method of motion vector derivation for video coding”. The U.S. Provisional patent applications are hereby incorporated by reference in their entireties.

### TECHNICAL FIELD

The present invention relates to video coding. In particular, the present invention relates to derivation of motion vector prediction in three-dimensional (3D) video coding.

### BACKGROUND

Three-dimensional (3D) television has been a technology trend in recent years that is targeted to bring viewers sensational viewing experience. Various technologies have been developed to enable 3D. Among them, the multi-view video is a key technology for 3DTV application among others. The traditional video is a two-dimensional (2D) medium that only provides viewers a single view of a scene from the perspective of the camera. However, the multi-view video is capable of offering arbitrary viewpoints of dynamic scenes and provides viewers the sensation of realism.

The multi-view video is typically created by capturing a scene using multiple cameras simultaneously, where the multiple cameras are properly located so that each camera captures the scene from one viewpoint. Accordingly, the multiple cameras will capture multiple video sequences. In order to provide more views, more cameras have been used to generate multi-view video with a large number of video sequences associated with the views. Accordingly, the multi-view video will require a large storage space to store and/or a high bandwidth to transmit. Therefore, multi-view video coding techniques have been developed in the field to reduce the required storage space of the transmission bandwidth. A straightforward approach may simply apply conventional video coding techniques to each single-view video sequence independently and disregard any correlation among different views. In order to improve multi-view video coding efficiency, typical multi-view video coding always exploits inter-view redundancy.

Motion vector prediction (MVP) is an important video coding technique that codes motion vector (MV) of current block predictively to improve coding efficiency. Motion vector prediction derives motion vector predictors (MVPs) for coding the motion vector (MV) of a current block. The derivation of the motion vector predictors is based on already coded video data so that the same derivation can be performed at the decoder side. In some cases, the MVP may be the same as the current MV. An indication (Direct mode) can be signaled for this situation so that no motion information for the MV needs to be transmitted for the block. Furthermore, the residual prediction errors may be very small or may be zero for the selected MVP. An indication (Skip mode) can be signaled so that neither motion information nor residual signal needs to be transmitted for the block. The motion prediction technique can also be applied to three-dimensional video coding. Since all cameras capture the same scene from different viewpoints, a multi-view video will contain a large amount of inter-view redundancy. The inter-view motion prediction is employed to derive the inter-view motion vector predictor (MVP) candidate for motion vectors coded in various modes, such as a inter mode, Skip mode and Direct mode in H.264/AVC, AMVP mode, Merge mode and Skip mode in HEVC.

In the standard development of three-dimensional video coding, a method for depth-based motion vector prediction (D-MVP) is disclosed which uses available depth map data for coding/decoding of the associated texture data. This technique is able to enhance texture coding efficiency. This technique can be applied when depth map data is coded prior to the texture data. In case of the texture-first coding structure, available depth map data of the base view may be used by the dependent view. The D-MVP tool consists of two parts: direction-separated motion vector prediction (MVP) and depth-based motion vector (MV) competition for Skip and Direct modes.

Direction-Separated MVP. Conventional median based MVP of H.264/AVC is restricted to the same prediction directions of motion vector candidates. Therefore, the direction-separated MVP separates all available neighboring blocks according to the direction of the prediction (i.e., temporal or inter-view). An exemplary flowchart associated with the direction-separated MVP derivation process is illustrated in FIG. 1A. The inputs to the process include motion data 110 associated with blocks Cb, A, B and C, and depth map 120 associated with block Cb, where Cb is a collocated chroma block and blocks A, B and C are spatial neighboring blocks associated with the current block as shown in FIG. 1B. If the motion vector associated with block C is not available, the motion vector associated with block D is used. If a current chroma block Cb uses an inter-view reference picture (i.e., the “No” path from step 112), any neighboring block that does not utilize inter-view prediction are marked as unavailable for MVP derivation (step 114). Similarly, if the current chroma block Cb uses temporal prediction (i.e., the “Yes” path of step 112), any neighboring block that uses inter-view reference frames is marked as unavailable for MVP derivation (step 132).

If no motion vector candidates are available from the neighboring blocks, the default “zero-MV” MVP (i.e., mv_{y}=0, mvₓ=0 in step 116) for inter-view prediction is replaced by mv_{y}=0 and mvₓ= D̅(cb), where D̅(cb) is the average disparity associated with the texture of the current block Cb (step 122) according to equation (1):

D̅(cb)=(1/N)·ΣᵢD(cb(i)), (1)

where i is the index of pixels within Cb, and N is the total number of pixels in the depth map of Cb. The temporal MVP 134 or the inter-view MVP 116 is then provided for MV coding (step 118).

Depth-based MV Competition for Skip and Direct Modes. Flowcharts of the process for the Depth-based Motion Competition (DMC) in the Skip and Direct modes are shown in FIG. 2A and FIG. 2B respectively. The inputs to the process include motion data 210 associated with blocks A, B and C, and depth map 220 associated with block Cb and blocks A, B and C. The block configuration of Cb, A, B and C are shown in FIG. 1B. In the Skip mode, motion vectors {mvᵢ} of texture data blocks {A, B, C} are separated into respective temporal and inter-view groups (step 212) according to their prediction directions. The DMC is performed separately for temporal MVs (step 214) and inter-view MVs (step 222).

For each motion vector mv, within a given group (temporal or inter-view), a motion-compensated depth block d(cb,mvᵢ) is derived, where the motion vector mv, is applied to the position of d(cb) to obtain the depth block from the reference depth map pointed to by the motion vector mvᵢ. The similarity between d(cb) and d(cb,mvᵢ) is then estimated according to equation (2):

SAD(mvᵢ)=SAD(d(cb,mvᵢ),d(cb)). (2)

The mvᵢ that achieves the minimum sum of absolute differences (SAD) within a given group is selected as the optimal predictor for the group in a particular direction (mvp_{dir}), i.e.

$${mvp}_{dir} = arg {min}_{{mvp}_{dir}} ( SAD ( m {v}_{i} ) ) . \qquad ( 3 )$$

The predictor in the temporal direction (i.e., mvpₜₘₚ) competes against the predictor in the inter-view direction (i.e., mvpᵢₙₜₑᵣ). The predictor that achieves the minimum SAD can be determined according to equation (4) for the Skip mode (step 232):

$${mvp}_{opt} = arg {min}_{{mvp}_{dir}} ( SAD ( {mvp}_{tmp} ) , SAD ( {mvp}_{inter} ) ) . \qquad ( 4 )$$

Finally, if the optimal MVP mvpₒₚₜ refers to another view (inter-view prediction), the following check is applied to the optimal MVP. In the case that the optimal MVP corresponds to “Zero-MV”, the optimal MVP is replaced by the “disparity-MV” predictor (step 234) and the derivation of the “disparity-MV” predictor is shown in equation (1). The final MVP is used for Skip mode as shown in step 236.

The flowchart of MVP derivation for the Direct mode of B slices is illustrated in FIG. 2B, which is similar to that for the Skip mode. However, DMC is performed over both reference pictures lists (i.e., List 0 and List 1) separately (step 242). Therefore, for each prediction direction (temporal or inter-view), DMC produces two predictors (mvp0_{dir} and mvp1_{dir}) for List 0 and List 1 respectively (step 244 and step 254). The bi-direction compensated blocks (steps 246 and step 256) associated with mvp0_{dir} and mvp1_{dir} are computed according to equation (5):

$$d ( cb , {mvp}_{dir} ) = \frac{d ( cb , mvp {0}_{dir} ) + d ( cb , mvp {1}_{dir} )}{2} \cdot \qquad ( 5 )$$

The SAD value between this bi-direction compensated block and Cb is calculated according to equation (2) for each direction separately. The MVP for the Direct mode is then selected from available mvpᵢₙₜₑᵣ and mvpₜₘₚ (step 262) according to equation (4). If the optimal MVP mvpₒₚₜ refers to another view (i.e., MVP corresponding to inter-view prediction), the following check is applied to the optimal MVP. If the optimal MVP corresponds to “Zero-MV”, the “zero-MV” in each reference list is replaced by the “disparity-MV” predictor (step 264) and the derivation of the “disparity-MV” predictor is shown in (1). The final MVP is used for the Direct mode as shown in step 266.

The MVP derivation for the Skip and Direct modes based on D-MVP is very computationally intensive. For example, the average disparity associated with the texture of the current block Cb has to be calculated as shown in equation (1), where a summation over N depth data has to be performed. There are various further operations as shown in equation (2) through (5) that have to be performed. It is desirable to develop simplified MVP derivation schemes for the Skip and Direct modes in three-dimensional video coding.

### SUMMARY

A method and apparatus for deriving MVP (motion vector predictor) for Skip mode, Direct mode or Merge mode in three-dimensional video coding are disclosed. In one embodiment, the method comprises determining an MVP candidate set for a selected block in a picture and selecting one MVP from an MVP list for motion vector coding of the block. The MVP candidate set may comprise at least one spatial MVP candidate associated a plurality of neighboring blocks and one inter-view candidate for the selected block, and the MVP list is selected from the MVP candidate set. The MVP list may consist of only one MVP candidate or multiple MVP candidates. If only one MVP candidate is used, there is no need to incorporate an MVP index associated with the MVP candidate in the video bitstream corresponding to the three-dimensional video coding. When only one MVP candidate is used, the MVP candidate can be the first available MVP candidate from the MVP candidate set according to a pre-defined order. When two or more MVP candidates are used to form the MVP list, an MVP index will be included in a video bitstream to indicate the selected MVP candidate. The neighboring blocks may comprise a left neighboring block, an above neighboring block and an upper-right neighboring block. If the upper-right neighboring block has no motion vector available, the upper-left neighboring block will be included in the candidate set. The inter-view candidate can be derived based on a derived disparity value associated with the selected block, wherein the derived disparity value maps the selected block to a pointed block (or so called corresponding block), and motion vector associated with the pointed block (or so called corresponding block) is used as said inter-view candidate. The derived disparity value can be derived based on disparity vectors associated with the neighboring blocks, depth data of the selected block, or both the disparity vectors associated with the plurality of the neighboring blocks and the depth data of the selected block. Here, the depth data of the selected block can be real depth data of the selected block or virtual depth data which warped from other views.

### BRIEF DESCRIPTION OF DRAWINGS

FIG. 1A illustrates an exemplary flowchart associated with the direction-separated MVP derivation (D-MVP) process.

FIG. 1B illustrates configuration of spatial neighboring blocks and a collocated block for the direction-separated MVP derivation (D-MVP) process.

FIG. 2A illustrates an exemplary flowchart of the derivation process for Depth-based Motion Competition (DMC) in the Skip mode.

FIG. 2B illustrates an exemplary flowchart of the derivation process for the Depth-based Motion Competition (DMC) in the Direct mode.

FIG. 3 illustrates an example of spatial neighboring blocks, temporal collocated blocks, and inter-view collocated block associated with MVP candidate derivation in three-dimensional (3D) video coding.

FIG. 4 illustrates an example of deriving the inter-view MVP (IMVP) based on the central point of the current block in the current view, the MV of a block covering the corresponding point in the reference view, and the DV of the neighboring blocks.

### DETAILED DESCRIPTION

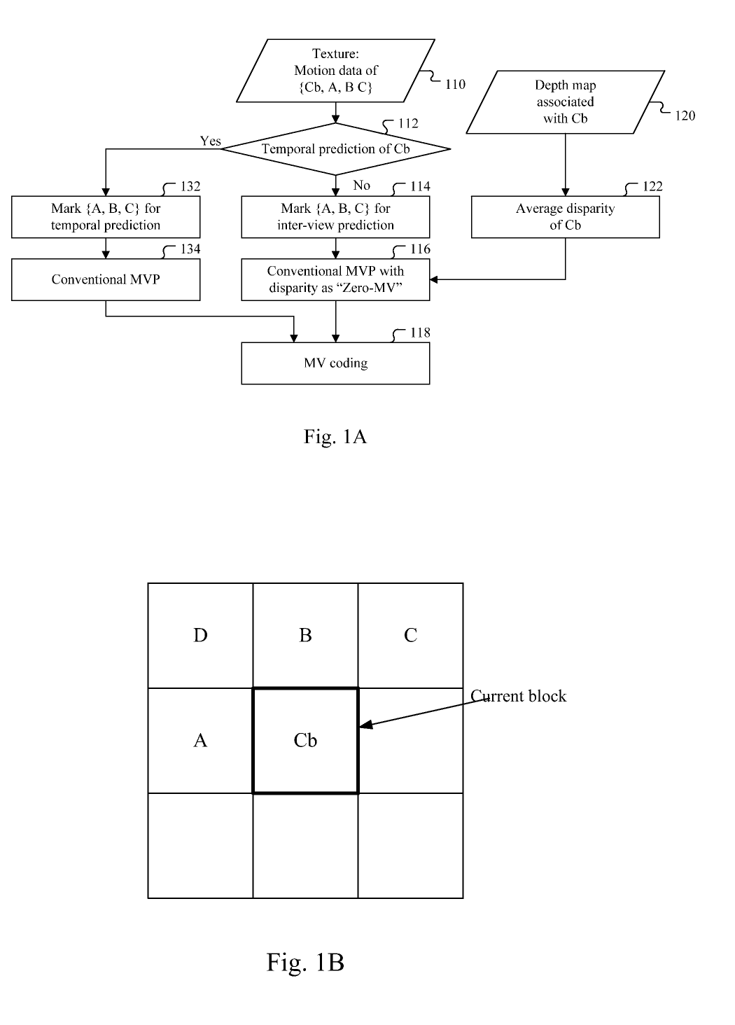

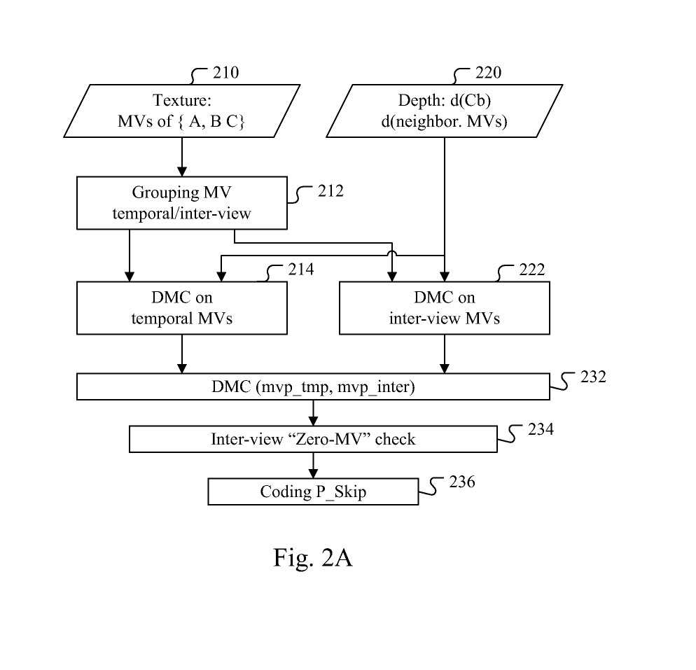

In the present invention, the MVP is derived from the motion vectors associated with spatial neighboring blocks and a corresponding block (or so called collocated block). In one embodiment, the final MVP may be selected from the MVP candidate set according to a pre-defined order. In this case, the selected motion vector prediction/disparity vector prediction (MVP/DVP) index is explicitly signaled so that the decoder can determined the selected MVP/DVP. The candidate set comprises motion vectors or disparity vectors associated with neighboring blocks A, B, and C as shown in FIG. 1B. After removing any redundant candidate and unavailable candidate, such as the case corresponding to an Intra-coded neighboring block, the encoder selects one MVP among the MVP candidate set and transmits the index of the selected MVP to the decoder. If there is only one candidate remaining after removing redundant candidates, there is no need to transmit the MVP index. If the candidate set is empty (i.e., none of the candidates is available), a default candidate such as zero MV is added, where the reference picture index can be set to 0.

For Skip and Direct modes at the decoder side, the motion compensation is performed based on the motion information of the selected MVP as indicated by the MVP index or inferred (i.e., single MVP candidate remaining or none after removing redundant MVP candidates). The motion information may include the inter prediction mode (i.e., uni-direction prediction or bi-direction prediction), prediction direction (or so called prediction dimension) (i.e., temporal prediction, inter-view prediction, or virtual reference frame prediction), and reference index.

MVP Index Coding. The binarization codewords for the selected MVP index can be implemented using the unary binarization process, the truncated unary binarization process, the concatenated unary, k-th order Exp-Golomb binarization process, or the fixed-length binarization process. Table 1 shows an example of the binarization table for MVP index using the truncated unary process.

TABLE 1

| Value of MVP Index | Bin string | | | | |
|---|---|---|---|---|---|
| 0 | 0 | | | | |
| 1 | 1 | 0 | | | |
| 2 | 1 | 1 | 0 | | |
| 3 | 1 | 1 | 1 | 0 | |
| 4 | 1 | 1 | 1 | 1 | 0 |
| 5 | 1 | 1 | 1 | 1 | 1 |
| . . . | | | | | |
| binIdx | 0 | 1 | 2 | 3 | 4 |

The binarized MVP index can be coded using context-based adaptive binary arithmetic coding (CABAC). In the first example, each bin may have its own probability model. In the second example, the context model of each bin may use the information regarding whether its neighboring block(s) uses Skip or Direct mode. If the neighboring block(s) uses Skip or Direct mode, the context model of each bin uses the MVP index of the neighboring block. In the third example, some bins have their own probability model and others use the information of its neighboring block(s) for context modeling (i.e., the same as the second example). In the fourth example, each bin may have its own probability model except for the first bin. First bin has its probability model depending on the statistics of neighboring coded data symbols. For example, the variables condTermFlagLeft and condTermFlagAbove are derived as follows:

if LeftMB is not available or MVP index for the LeftMB is equal to 0,
condTermFlagLeft is set to 0;
otherwise,

condTermFlagLeft is set to 1,

where LOMB corresponds to the left macroblock of the current macroblock. In another example, the variables condTermFlagLeft and condTermFlagAbove are derived as follows:

if AboveMB is not available or MVP index for the AboveMB is equal to
0,

condTermFlagAbove is set to 0.

otherwise,

condTermFlagAbove is set to 1,

where AboveMB is the above macroblock of the current macroblock.

The probability models for the first bin is then selected based on variable ctxIdxInc, which is derived according to:

ctxIdxInc=condTermFlagLeft+condTermFlagAbove.

The probability model for this bin can also be derived according to:

ctxIdxInc=condTermFlagLeft×2+condTermFlagAbove, or

ctxIdxInc=condTermFlagLeft+condTermFlagAbove×2.

In the fifth example, some bins, except for the first bin, may also use context modeling method described in the fourth example to select a proper probability model.

Other Candidates. The neighboring block D as shown in FIG. 1B can also be included in the candidate set or the neighboring block D is used to replace the neighboring block C conditionally when the MVP associated with block C is unavailable.

The temporal candidate can also be included in the MVP candidate set. The temporal candidate is the MVP or DVP derived from the temporal blocks in a temporal collocated picture from list 0 or list 1. Some exemplary derivations of temporal candidate are disclosed as follows.

In the first example, the temporal candidate can be derived from an MV of a temporal block if a temporal candidate is used to predict the current MV. In the case that the temporal candidate is used to predict a disparity vector (DV), the temporal candidate is derived from a DV of a temporal block. In the case that the temporal candidate is used to predict a virtual MV pointing to a synthesized virtual reference picture, the temporal candidate is either derived from a virtual MV of a temporal block or a zero vector is used as a temporal candidate.

In the second example, the temporal candidate can be derived from an MV, DV or a virtual MV of a temporal block regardless of whether the temporal candidate is used to predict an MV, DV or a virtual MV. In the third example, the temporal candidate is derived by searching for an MV or a DV of a temporal block with the same reference list as a given reference list, where the temporal candidate is derived based on the method described in the first or the second example. The derived MV or DV is then scaled according to the temporal distances or inter-view distances.

In the fourth example, the temporal candidate can be derived by searching for an MV of a temporal block for a given reference list and a collocated picture, where the MV crosses the current picture in the temporal dimension. The temporal candidate is derived based on the method as described in the first or the second example. The derived MV is then scaled according to temporal distances.

In the fifth example, the temporal candidate can be derived for a given reference list and a collocated picture according to the following order:

1. Search for an MV of a temporal block and select the MV if the MV exists, where the MV crosses the current picture in the temporal dimension.

2. If both the list-0 and list-1 MVs cross the current picture or if both do not cross the current picture, the one with the same reference list as the current list will be chosen.

The temporal candidate is derived based on the method described in the first or the second example. The derived MV is then scaled according to the temporal distances.

In the sixth example, the temporal candidate can be derived for a given reference list based on the list-0 or list-1 MV or DV of a temporal block in the list-0 or list-1 temporal collocated picture according to a given priority order. The temporal candidate is derived based on the method described in the first or the second example. The priority order is predefined, implicitly derived, or explicitly transmitted to the decoder. The derived MV or DV is then scaled according to the temporal distances or inter-view distances. An example of the priority order is shown as follows, where the current list is list 0:

1. Scaled the list-0 MV or DV of the temporal block in the list-1 temporal collocated picture.

2. Scaled the list-1 MV or DV of the temporal block in the list-0 temporal collocated picture.

3. Scaled the list-0 MV or DV of the temporal block in the list-0 temporal collocated picture.

4. Scaled the list-1 MV or DV of the temporal block in the list-1 temporal collocated picture.

For the derivation of the reference index, the index can be implicitly derived based on the median, mean, or the majority of the reference indices associated with spatial neighboring blocks. The reference index can also be implicitly derived as if the current picture were pointing to the same reference picture that is referred to by the temporal collocated block. If the reference picture referred to by the temporal collocated block is not in the reference picture list of the current picture, the reference picture index can be set to a default value such as zero.

For temporal candidate derivation, the information to indicate whether the collocated picture is in list 0 or list 1 and which reference picture is the temporal collocated picture can be implicitly derived or explicitly transmitted at different levels. For example, the information can be incorporated in the sequence, picture, slice, largest coding unit, coding unit of a particular depth, leaf coding unit, macroblock, or sub-macroblock level.

The inter-view candidate can also be included in the MVP candidate set. The inter-view candidate is the MVP derived from the inter-view collocated block (or so called corresponding block) in an inter-view collocated picture from list 0 or list 1. The position of the inter-view collocated block can simply be the same as that of the current block in the inter-view collocated picture or can be derived by using a global disparity vector (GDV) or warping the current block onto the inter-view collocated picture according to the depth information or can be derived by using the disparity vectors associated with spatial neighboring blocks.

For the derivation of the inter-view candidate, the information to indicate whether the inter-view collocated picture is in list 0 or list 1 can also be implicitly derived or explicitly transmitted at different levels. For example, the information can be incorporated in the sequence, picture, slice, largest coding unit, coding unit of a particular depth, leaf coding unit, macroblock, or sub-macroblock level.

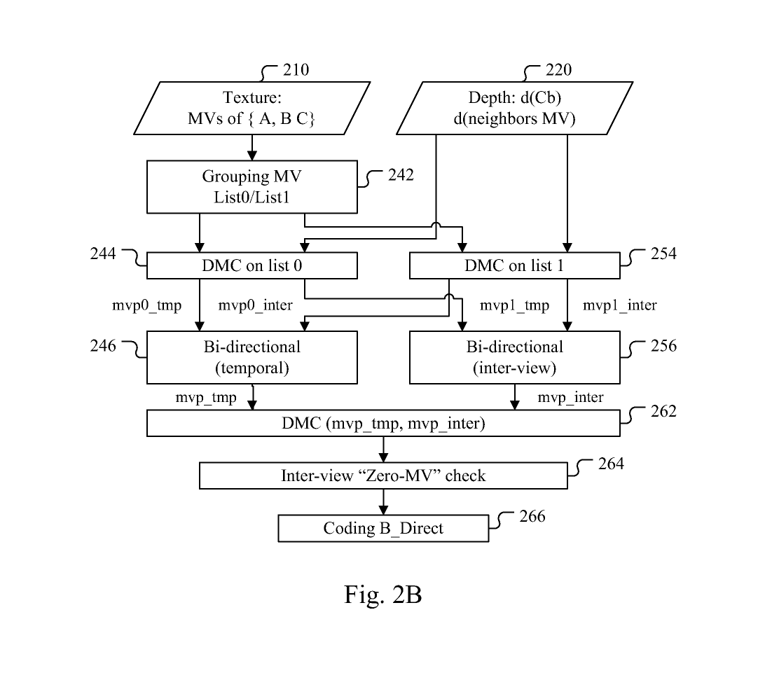

FIG. 3 illustrates a scenario that the MV(P)/DV(P) candidates for a current block are derived from spatially neighboring blocks, temporally collocated blocks in the collocated pictures in list 0 (L0) or list 1(L1), and inter-view collocated blocks in the inter-view collocated picture. Pictures 310, 311 and 312 correspond to pictures from view V0 at time instances T0, T1 and T2 respectively. Similarly, pictures 320, 321 and 322 correspond to pictures from view V1 at time instances T0, T1 and T2 respectively and pictures 330, 331 and 332 correspond to pictures from view V2 at time instances T0, T1 and T2 respectively. The pictures shown in FIG. 3 can be the color images or the depth images. The derived candidates are termed as spatial candidate (spatial MVP), temporal candidate (temporal MVP) and inter-view candidate (inter-view MVP). In particular, for temporal and inter-view candidate derivation, the information to indicate whether the collocated picture is in list 0 or list 1 can be implicitly derived or explicitly transmitted in different levels of syntax (e.g. sequence parameter set (SPS), picture parameter set (PPS), adaptive parameter set (APS), Slice header, CU level, largest CU level, leaf CU level, or PU level). The position of the inter-view collocated block can be determined by simply using the same position of the current block or using a Global Disparity Vector (GDV) or warping the current block onto the collocated picture according to the depth information or can be derived by using the disparity vectors associated with spatial neighboring blocks.

MVP Candidate List Derived for Each Direction Independently. The MVP index of each direction (List 0 or List 1) is transmitted independently according to this embodiment. The candidate list for each direction can be constructed independently. The candidate set may include the spatial candidates, the temporal candidate(s), and/or the inter-view candidate(s). If none of the candidates is unavailable, a default MVP/MVD is added. After removing any redundant candidate and unavailable candidate, one final candidate is selected and its index is transmitted to the decoder for each candidate list.

On the decoder side, for each direction (List 0 or List 1), a uni-directional motion compensation is performed based on the motion information of the selected MVP candidate. The motion information may include the prediction direction (or so called prediction dimension, i.e. temporal prediction, inter-view prediction, or virtual reference frame prediction) and the reference index. For uni-directional prediction mode, such as the Skip mode in the AVC-based 3DVC, only one candidate list needs to be constructed and only one index needs to be transmitted in the case that the size of candidate list is larger than 1 after removing any redundant or unavailable candidate. If the size of candidate list is equal to 1 or 0 after removing any redundant or unavailable candidate, there is no need to transmit the index. For bi-directional prediction mode, such as Direct mode in the current AVC-based 3DVC, two candidate lists need to be constructed independently and the index of each candidate list needs to be transmitted to the decoder when the size of candidate list is larger than 1 after removing any redundant or unavailable candidate. On the decoder side, the final motion compensated block is the result of the weighting sum of two motion compensated blocks on List 0 and List 1 according to the final selected candidates of List 0 and List 1.

The Candidate Order. In one embodiment of the present invention, the derived spatial candidates, temporal candidates, inter-view candidates or any other types of candidates are included in the candidate set in a predefined order.

Based on the predefined order of the MVP set, the first available one is defined as the final MVP. If the MVP candidate set has no available MVP, a default MVP, such as a zero MVP, can be used. The derived MVP can be used in the Skip, Direct, or Inter mode. In the Direct mode of H.264/AVC, the derived spatial MVP (SMVP) may be changed to a zero vector according to a check procedure which checks the motion information of a collocated block in the temporal collocated picture. In one embodiment of the present invention, if the final MVP is an SMVP, this check procedure can also be applied to set the MVP to a zero vector. However, if the final MVP is not SMVP, this check can be omitted. For example, the MVP candidate set contains one IMVP, and four SMVP derived from the neighboring blocks A, B, C, and D (D is only used when MV/DV associated with C is not available). The predefined order for the MVP set is: IMVP, SMVP A, SMVP B, SMVP C, SMVP D. If the IMVP exists, it is used as the final MVP in the Skip or Direct mode. Otherwise, the first available SMVP is used as the final MVP in the Skip or Direct mode. If none of the MVPs exists, a zero MV is used as the final MVP.

In another example, the MVP candidate set only contains one IMVP. In this case, the order is not required. If the IMVP is not available, a default MVP, such as a zero MV can be used. The derived MVP can also be used in the Inter mode. In that case, the motion vector difference (MVD) will also be transmitted to the decoder.

The order for the MVP set can be implicitly derived. For example, the order of the IMVP can be adjusted according to the depth value of the current block.

The method can be extended to motion vector competition (MVC) scheme by explicitly sending an index to the decoder to indicate which MVP in the MVP set is the final MVP. Furthermore, a flag, syntax or size can used to indicate whether the MVP is derived based on a given order or it is indicated by explicitly signaling the MVP index. The flag, syntax or size can be implicitly derived or explicitly transmitted at different levels. For example, the flag, syntax or size can be incorporated in the sequence, picture, slice, largest coding unit, coding unit of a particular depth, leaf coding unit, macroblock, or sub-macroblock level.

When Skip/Direct mode has more than one MVP schemes to choose from, one or more flags are signaled to indicate which scheme is used. For example, when an MB is signaled as a Skip/Direct mode, view synthesis prediction (VSP) Skip/Direct provides another way of utilizing VSP frames as references when multiple VSP frames exist in the reference picture list. In this case, one flag is further signaled to indicate the VSP Skip/Direct mode or the MVP scheme for non-synthesized frames is used for this Skip/Direct coded MB.

Some exemplary orders are illustrated as follows:

Order 0: spatial candidate A=>spatial candidate B=>spatial candidate C (D),

Order 1: spatial candidates (based on Order 0)=>temporal candidate,

Order 2: spatial candidates (based on Order 0)=>inter-view candidate,

Order 3: temporal candidate=>spatial candidates (based on Order 0),

Order 4: inter-view candidate=>spatial candidate (based on Order 0),

Order 5: spatial candidates (based on Order 0)=>inter-view candidate=>temporal candidate,

Order 6: spatial candidates (based on Order 0)=>temporal candidate=>inter-view candidate,

Order 7: inter-view candidate=>temporal candidate=>spatial candidates (based on Order 0),

Order 8: temporal candidate=>inter-view candidate=>spatial candidates (based on Order 0),

where C(D) means that block D is used to replace block C when the MV associated with block C is unavailable. The order can also be adapted to the depth information of the current block and the block pointed to by the inter-view MVP. For example, order 4 is used if the depth difference of the current block and the block pointed to by inter-view MVP is smaller than a certain threshold. Otherwise, order 6 is used. The threshold can be derived from the depth of the current block and camera parameters.

Fixed Size of Candidate List. To increase the decoder-side bitstream parsing throughput or solve the parsing error issue, the size of the candidate set is fixed according to another embodiment of the present invention. The size can be predefined or explicitly transmitted at different bitstream levels. For example, the size information can be incorporated in the sequence, picture, slice, largest coding unit, coding unit of a particular depth, leaf coding unit, macroblock, or sub macroblock level. If the size equals to N, then up to N candidates are included in the candidate set. For example, only the first N non-redundant candidates according to a given order can be included in the candidate set. If the number of available candidates after removing any redundant candidate is smaller than the fixed size, one or more other default candidates can be added to the candidate set. For example, a zero-MV candidate or additional candidates can be added into the candidate set in this case. The additional candidate can be generated by adding an offset value to the available MV/DV or combining two available MVs/DVs. For example, the additional candidate may include the MV/DV from list 0 of one available candidate and the MV/DV from list 1 of another available candidate. After the additional candidates are considered, if the number of non-redundant candidates is M and M is smaller than N, the encoder may send an MVP index with a value from 0 to M−1. The encoder may also send an MVP index with a value from 0 to N−1, where the MVP index with a value larger than M can represent a default MVP such as zero MVP.

Various MVP derivation methods as mentioned above can be combined. For example,

Candidates: spatial candidate A, B, C(D)

Derivation order: Order 0

Candidate list size: Adaptive.

In another example,

Candidates: spatial candidate A, B, C(D) and one inter-view candidate

Derivation order: Order 4

Candidate list size: Fixed.

Inter-View MVP (IMVP) Derivation. In another embodiment of the present invention, a Direct/Skip mode is based on the inter-view MVP. The inter-view MVP is derived from the inter-view collocated block in an inter-view collocated picture from list 0 or list 1. The position of the inter-view collocated block can simply be the same as that of the current block in the inter-view collocated picture. Alternatively, the inter-view MVP can be derived based on the disparity vector of neighboring blocks or a global disparity vector (GDV). The inter-view MVP may also be derived by warping the current block onto the inter-view collocated picture according to the depth information. The information indicating whether the inter-view collocated picture is in list 0 or list 1 can be implicitly derived or explicitly transmitted at different levels. For example, the information can be incorporated in the sequence, picture, slice, largest coding unit, coding unit of a particular depth, leaf coding unit, macroblock, or sub-macroblock level.

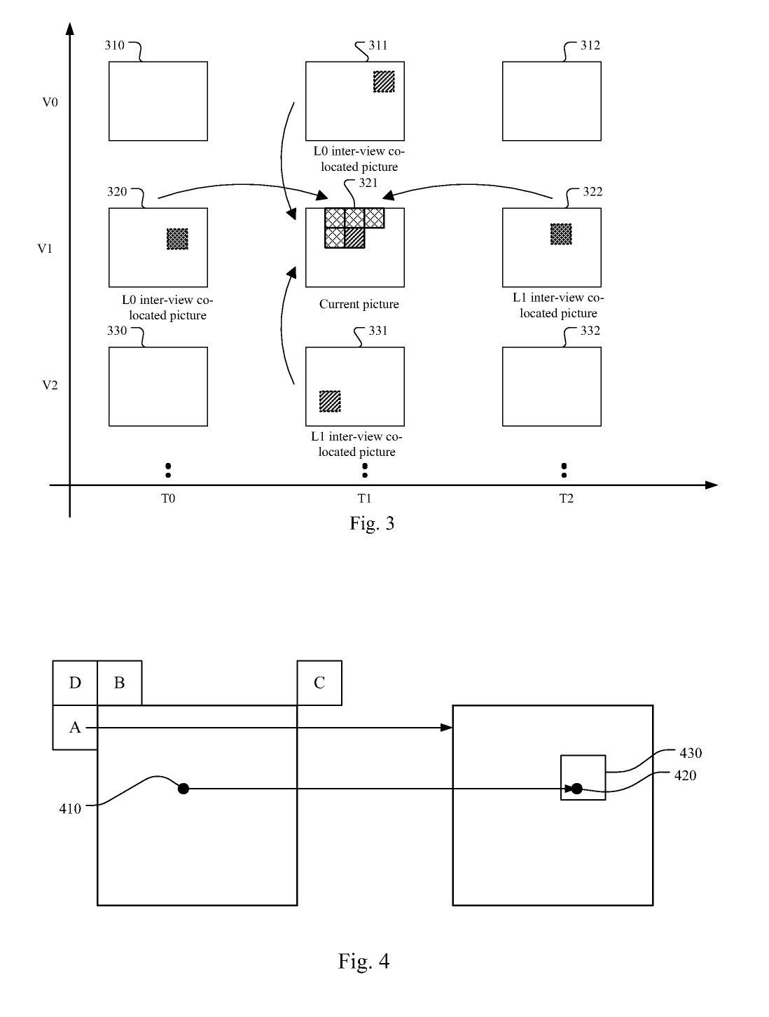

Various examples of inter-view MVP (IMVP) derivation are described as follows. In the first example, the inter-view MVP candidate is derived based on a central point 410 of the current block in the current view (i.e., a dependent view) as shown in FIG. 4. The disparity associated with the central point 410 is used to find the corresponding point 420 in the reference view (a base view). The MV of the block 430 that covers the corresponding point 420 in the reference view is used as the inter-view MVP candidate of the current block. The disparity can be derived from both the neighboring blocks and the depth value of the central point. If one of the neighboring blocks has a DV, (e.g. DV_{A} for block A in FIG. 4), the DV is used as the disparity. Otherwise, the depth-based disparity is used, where the disparity is derived using the depth value of the central point and camera parameters. Compared to the approach that only uses the depth-based disparity, the approach that uses DVs from spatial neighboring blocks can reduce error propagation in case that the depth value of the central point is unavailable. For example, the depth image may be lost. When the corresponding block pointed to by the DV of the neighboring block has no available motion information, the inter-view candidate derivation process can continue based on the DV of the next neighboring block. Alternatively, the inter-view candidate derivation process can be based on the disparity derived from the depth of the current block. The inter-view candidate derivation process will continue until a corresponding block with valid motion information is derived or none of the DVs of the neighboring blocks is available. When a corresponding block pointed to by the DV of the neighboring block is intra coded or use an invalid reference picture for the current picture, the corresponding block is considered as having no available motion information.

In the second example, the disparity derived based on the current block is first used to find a corresponding block. If a corresponding block pointed to by the disparity derived from the current block has no available motion information, the inter-view candidate derivation process can continue based on the DV of the next neighboring block. Again, when a corresponding block pointed to by the DV of the neighboring block is intra coded or use an invalid reference picture for the current picture, the corresponding block is considered as having no available motion information.

In the first and second examples described above, the inter-view MVP is derived from a corresponding block in the base view. During the MVP derivation process, it is possible that there is no available reference picture having the same time stamp as the reference picture for the corresponding block. According to the third example, the MV candidate can be set to “unavailable” or the MV can be scaled according to the temporal distance of a default reference picture in this case. For example, the first reference picture in the reference picture buffer can be designated as the default reference picture.

In the fourth example, the disparity mentioned in examples 1 to 3 can always be derived from the depth value of the central point 410. Alternatively, the disparity is always derived from the depth value of point (0,0) in the fifth example. In the sixth example, the disparity can be derived from both the neighboring blocks and the depth value of the point (0,0). If one of the neighboring blocks has disparity vector (DV), (e.g. DV_{A} for block A in FIG. 4), the DV is used as the disparity. Otherwise, the depth-based disparity is used, where the disparity is derived using the depth value of point (0,0) and camera parameters. In the seventh example, the disparity can be derived from the average of the depth values of the current block. In the eighth example, the disparity can be derived from both the neighboring blocks and the average disparity value of the current block. If one of the neighboring blocks has a DV, (e.g. DV_{A} for block A in FIG. 4), the DV is used as the disparity. Otherwise, the depth-based disparity is used, where the average disparity values of the current block is used. In the ninth example, the disparity can be derived from the weighted sum of the DVs of the neighboring blocks.

In the tenth example, the disparity can be derived from both the neighboring blocks and the depth value of the point (7,7), or the neighboring blocks and the average disparity value of the current block. When the depth of the current block is smooth, the depth-based disparity can be used, which is derived using the average depth value of the current block and camera parameters. If the depth of the current block is not smooth and one of the neighboring blocks has a DV, (e.g. DV_{A} for block A in FIG. 4), the DV is used as the disparity. If the depth of the current block is not smooth and none of the neighboring blocks has a DV, the depth-based disparity is used, which is derived using the depth value of point (7,7) and camera parameters. The smoothness of a depth block can be determined according to the characteristic of the block. For example, the sum of the absolute difference (SAD) between the depth value and the average depth value of the current block can be measured. If the SAD is smaller than or equal to a threshold (e.g., 12), the block is considered to be smooth. Otherwise, the block is considered to be non-smooth.

In the eleventh example, the disparity can be derived from both the neighboring blocks or the depth value of point (7,7). If the depth of the current block is not smooth, the inter-view candidate is set as unavailable. If the depth of the current block is smooth and one of the neighboring blocks has a DV (e.g. DV_{A} for block A in FIG. 4), the DV is used as the disparity. If the depth of the current block is smooth and none of the neighboring blocks has a DV, the depth-based disparity is used, which is derived using the depth value of point (7,7) and camera parameters. The smoothness of the current depth block can be determined using the method mentioned above.

In a twelfth example, the disparity can be derived from the neighboring blocks or depth value of the point (7,7), or the neighboring blocks and the average disparity value of the current block. If the depth of the current block is not smooth, the depth-based disparity is used, which is derived using the average depth value of the current block and camera parameters. If the depth of the current block is smooth and one of the neighboring blocks has a DV (e.g. DV_{A} for block A in FIG. 4), the DV is used as the disparity. If the depth of the current block is smooth and none of the neighboring blocks has a DV, the depth-based disparity is used, which is derived using the depth value of point (7,7) and camera parameters. Again, the smoothness of the current depth block can be determined using the method mentioned above.

Inter-View Picture Selection. One aspect of the present invention addresses the selection of the inter-view picture. Various examples of inter-view picture selection according to the present invention are described as follows and the following selection methods can be applied selectively.

1. Only the inter-view pictures in reference list 0 of the current picture can be used for inter-view MVP derivation.

2. Only the inter-view pictures in reference list 1 of the current picture can be used for inter-view MVP derivation.

3. Only the inter-view pictures in reference list 0 or list 1 of the current picture can be used for inter-view MVP derivation.

4. Only the inter-view picture in the base view can be used for inter-view MVP derivation.

5. Only the inter-view picture which is in the base view and in the reference list (list 0 or list 1) of the current picture can be used for inter-view MVP derivation.

6. Only the first available inter-view picture in the reference list (list 0 or list 1) of the current picture can be used for inter-view MVP derivation. The scan order can be:

a. first scan pictures in list 0 in the ascending order of the reference index and then scan pictures in list 1 in the ascending order of the reference index, or

b. first scan pictures in the reference list which is the same as that of the predicted MV in the ascending order of the reference index and then scan pictures in the other list in the ascending order of the reference index.

7. Only the inter-view picture which is in the reference list (list 0 or list 1) of the current picture with the smallest viewId can be used for inter-view MVP derivation.

Corresponding Block Locating. Another aspect of the present invention addresses the selection of corresponding block locations. To locate the corresponding block in the selected inter-view picture, the disparity vector (DV) can be derived using the following methods independently.

1. The DV is derived from the depth values of the current block:

a. The DV is derived from the depth value within a neighborhood of a center of the current block (e.g. the depth value of the left-top sample to the center of the current block as shown in FIG. 4),

b. The DV is derived from the average depth value of the current block,

c. The DV is derived from the maximum depth value of the current block, or

d. The DV is derived from the minimum depth value of the current block.

2. The DV is derived from the MVs of neighboring blocks (A, B, C, and D in FIG. 4, where D is used when the MV/DV associated with C is not available) that point to the selected inter-view picture in different orders: (general MV)

a. L0 MV of A=>L0 MV of B=>L0 MV of C,

b. L1 MV of A=>L1 MV of B=>L1 MV of C,

c. L0 MV of A=>L0 MV of B=>L0 MV of C=>L1 MV of A=>L1 MV of B=>L1 MV of C,

d. LX MV of A=>LX MV of B=>LX MV of C (LX represents the reference list same as that of the predicted MV),

e. LY MV of A=>LY MV of B=>LY MV of C (LY represent the reference list other than the one of the predicted MV), or

f. LX MV of A=>LX MV of B=>LX MV of C=>LY MV of A=>LY MV of B=>LY MV of C.

3. The DV is first derived using the method in 2. If no DV is derived, method 1 is then used to derive the DV.

Acquisition of Motion Parameters. Yet another aspect of the present invention addresses the acquisition of motion parameters. Given the target reference picture with the reference index and reference list (list 0 or list 1) of the predicted MV, the inter-view MVP can be obtained from the corresponding block using the following methods:

1. The MV which is in the given reference list and points to the target reference picture is used as the MVP candidate. (For example, if L0 is the current reference list and MV is in L0 and points to the target reference picture, the MV is used as the inter-view MVP.)

2. If no such MV exists in the given reference list and points to the target reference picture, the MV which is in the other reference list and points to the target reference picture is used as the MVP candidate.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of deriving MVP (motion vector predictor) in three-dimensional video coding, the method comprising:
determining an MVP candidate set for a selected block in a picture, wherein the MVP candidate set comprises at least one spatial MVP candidate derived from a plurality of neighboring blocks and one inter-view candidate for the selected block; and
selecting one MVP from an MVP list for motion vector coding of the block, wherein the MVP list is selected from the MVP candidate set.

2. The method of claim 1, wherein the MVP list consists of only one MVP candidate.

3. The method of claim 2, wherein no MVP index associated with said only one MVP candidate is included in a video bitstream corresponding to the three-dimensional video coding.

4. The method of claim 2, wherein said only one MVP candidate is a first available MVP candidate from the MVP candidate set according to a predefined order.

5. The method of claim 1, wherein the MVP list consists of two or more MVP candidates.

6. The method of claim 5, wherein an MVP index associated with said selecting one MVP from the MVP list is included in a video bitstream corresponding to the three-dimensional video coding.

7. The method of claim 1, wherein the plurality of neighboring blocks comprises a left neighboring block, an above neighboring block and an upper-right neighboring block.

8. The method of claim 7, wherein the plurality of neighboring blocks further comprises an upper-left neighboring block if the upper-right neighboring block has no motion vector available.

9. The method of claim 1, wherein said one inter-view candidate is derived based on a derived disparity value associated with the selected block, wherein the derived disparity value maps the selected block to a pointed block, and motion vector associated with the pointed block is used as said one inter-view candidate.

10. The method of claim 9, wherein the derived disparity value is derived based on disparity vectors associated with the plurality of neighboring blocks, depth data of the selected block, or both the disparity vectors associated with the plurality of neighboring blocks and the depth data of the selected block.

11. The method of claim 10, wherein the depth data of the selected block is real depth data of the selected block or virtual depth data warped from other views.

12. The method of claim 9, wherein the derived disparity value is derived based on the depth data at a central point, point (0, 0), point (7, 7), or an average depth value of the selected block.

13. The method of claim 9, wherein the depth data of the selected block is used to derive the derived disparity value if none of the disparity vectors associated with the plurality of neighboring blocks is available.

14. The method of claim 9, wherein the pointed block is associated with a base-view picture.

15. An apparatus for deriving MVP (motion vector predictor) in three-dimensional video coding, the apparatus comprising:
means for determining an MVP candidate set for a selected block in a picture, wherein the MVP candidate set comprises at least one spatial MVP candidate derived from a plurality of neighboring blocks and one inter-view candidate for the selected block; and
means for selecting one MVP from an MVP list for motion vector coding of the block, wherein the MVP list is selected from the MVP candidate set.

16. A method of deriving an inter-view candidate for motion vector coding in three-dimensional video coding, the method comprising:
deriving a disparity value based on a disparity vector associated with at least a neighboring block of a selected block in a picture;
if the disparity vector is unavailable, deriving the disparity value based on depth data of the selected block; and
determining the inter-view candidate based on the derived disparity value;
wherein the derived disparity value maps the selected block to a pointed block and motion vector associated with the pointed block is used as said inter-view candidate.

17. The method of claim 16, wherein the depth data of the selected block is real depth data of the selected block or virtual depth data warped from other views.

18. The method of claim 16, wherein the derived disparity value is derived based on the depth data at a central point, point (0, 0), point (7, 7), or an average depth value of the selected block.
